(19) United States
(12) Patent Application Publication
(10) Pub. No.: US 2016/0065528 A1
(43) Pub. Date: Mar. 3, 2016

(54) PROVIDING NOTIFICATION PERTAINING TO MESSAGE BASED ON MESSAGE TYPE

(71) Applicant: Lenovo (Singapore) Ptd. Ltd., New Tech Park (SG)

(72) Inventors: Arnold S. Weksler, Raleigh, NC (US); Russell Speight VanBlon, Raleigh, NC (US); Nathan J. Peterson, Durham, NC (US); John Carl Mese, Cary, NC (US)

(21) Appl. No.: 14/473,640

(22) Filed: Aug. 29, 2014

(51) Int. Cl. H04L 12/58; H04W 68/00

(52) U.S. Cl. CPC H04L 51/24; H04W 68/005; H04L 51/046

(57) ABSTRACT

in one aspect, a device includes a processor and a memory accessible to the processor. The memory bears instructions executable by the processor to receive a first message, identify at least a first type of message to which the first message pertains, and determine whether to provide a notification at the device pertaining to the first message based on the identification.

### FIELD The present application relates generally to providing a notification pertaining message based on a message type to which the message pertains.

### BACKGROUND

Typically, when a message is received at a device, a notification regarding the message is immediately provided at the device. However, there may be instances when receiving such a notification regarding a particular message may be undesirable or annoying. There are currently no adequate and/or cost-effective solutions for addressing the foregoing.

### SUMMARY

Accordingly, in one aspect a device includes a processor and a memory accessible to the processor. The memory bears instructions executable by the processor to receive a first message, identify at least a first type of message to which the first message pertains, and determine whether to provide a notification at the device pertaining to the first message based on the identification.

In another aspect, a method includes receiving a first message at a device and determining whether to provide a notification regarding the first message based on a first message type to which the first message pertains.

In still another aspect, an apparatus includes a first processor, a network adapter, and storage bearing instructions executable by a second processor for determining whether to provide an alert at a device pertaining to at least one message received at the device based on a message type to which the message pertains. The first processor transfers the instructions ever a network via the network adapter.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIG. 3 is a flow chart showing an example algorithm in accordance with present principles;

FIG. 4 is an example data table in accordance with present principles; and

FIGS. 5-9 are example user interfaces WO in accordance with present principles,

### DETAILED DESCRIPTION

This disclosure relates generally to device-based information. With respect to any computer systems discussed herein, a system may include server and client components, connected over a network such that data may be exchanged between the client and server components. The client components may include one or more computing devices including televisions (e.g. TVs, Internet-enabled TVs), computers such as desktops, laptops and tablet computers, so-called convertible devices (e.g. having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or inure browsers such as a browser made by Microsoft of Google or Mozilla other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single or multi-chip process that can execute logic by means of various lines such as address lines, data lines, and control lines and registers and shift registers. Moreover, any logical blocks, modules and circuits described herein can be implemented or performed, in addition to a general purpose processor, iii or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by e.g. a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g. that may not be a carrier wave) such as a random access memory (RAM), read-only memory (ROM) electrically erasable programmable read-only memory (EEPROM), compact disk read-only memory (CD-ROM) or other optical disk storage such as digital versatile disc (DVD), magnetic disk storage or other magnetic storage devices including removable thumb devices, etc. A connection may establish a computer medium. Such connections an include, as examples, hard-wired cables including fiber optics and coaxial wires and twisted pair wires. Such connections may include wireless communication connections including infrared and radio.

In example, a processor can access info don over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination, For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

“A system having one or more of A, B, and C” (likewise “a system having one or more of A, B, C” and “a system having one or more of A, B, C”) includes systems that have A alone, B alone, C alone, A and B together, A and C together, B and C together, and/or A, B, and C together, etc.

The term “circuit” or “circuitry” is used in the summary, description, and/or claims, As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

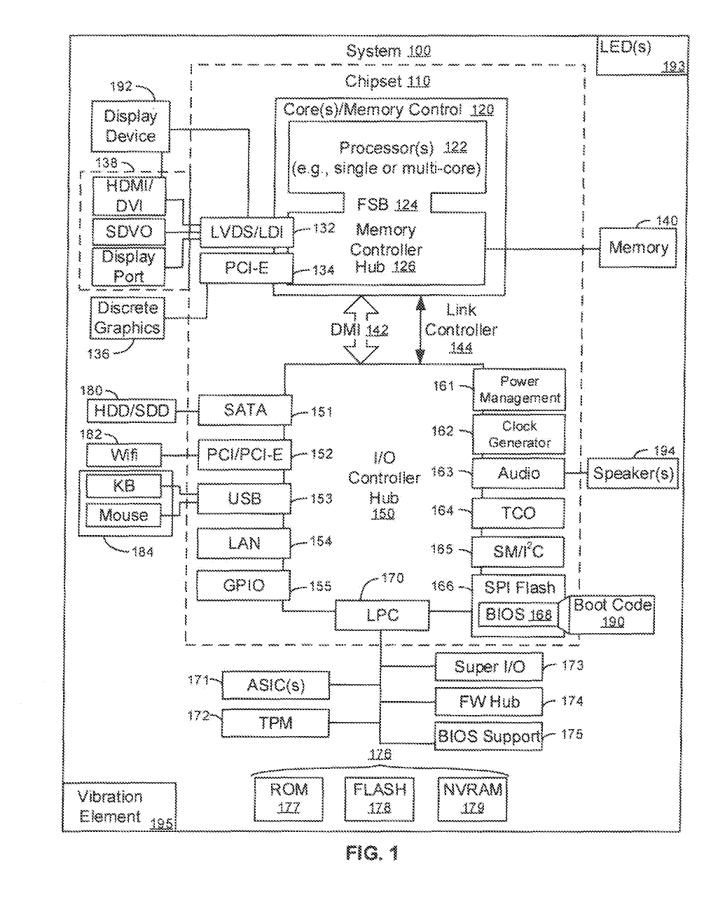

Now specifically in reference to FIG. 1 it shows an e ample block diagram of an information handling system and/or computer system 100. Note that in some embodiments the system 100 may be a desktop computer system, such as one of the ThinkCentre® or ThinkPad® series of personal computers sold by Lenore (US) Inc, of Morrisville, N.C. or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be e.g. game console such as XBOX® or Playstation®.

As shown. in FIG. 1, the system 100 includes a so-called chipset 110. A chipset refers to a group of integrated circuits, or chips, that are designed to work together. Chipsets are usually Marketed as a single product (e.g., consider chipsets marketed under the brands INTEL®, AMD®, etc).

In the example of FIG. 1, the chipset 110 has a particular architecture, which may vary to some extent depending on brand or manufacturer, The architecture of the chipset 110 includes a core and memory control you 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi core, etc.) and a memory controller hub 126 that exchange information via a front side bus (FSB) 124, As described herein, various components of the core and memory control group 120 may be integrated onto a single processor die, for example, to make a chip that supplants the conventional “northbridge” style architecture.

The memory controller hub 126 interfaces with memory 140, For example, the memory controller hub 126 may provide support DDR SDRAM memory (e.g., DDR, DDR2, DDR3, etc.)). In general, the memory 140 is a type of random-access memory (RAM). It is often referred to as “system memory.”

The memory controller hub 126 further includes a low-voltage differential signaling interface (LVDS) 132. The LVDS 132 may be a so-called LVDS Display Interface (LDI) for support of a display device 192 (e.g., a CRT a flat panel, a projector, a touch enabled display, etc.)), A block 138 includes some examples of technologies that may be supported via the LVDS interface 132 (e.g., serial digital video, HDMI/DVI, display port). The memory controller hub 126 also includes one or more PCI-express interfaces (PCI-E) 134 for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including e.g. one of more GPUs). An example system may include AGP or PCI-E for support of graphics.

The I/O hub controller 150 includes a variety of interfaces, The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc, under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof, but in any case the drives 180 are understood to be e.g. tangible computer readable storage mediums that may not be carrier waves. The I/O controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), nice and various other devices (e.g., cameras, phones, storage, media players, etc.)

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile. RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application soft are (e.g., stored in system memory 140). An operating system may be stored in any of a variety of locations and accessed, for example, according to instructions of the BIOS 168.

Also shown is at least one light 193 which may be e.g. a light emitting diode (LED). It is to be understood that the light 193 may be positioned at least partially on a portion of housing for the system 100 that does not form part of the display device 192, and/or may be positioned on a portion of the display device 192 such as e.g. a generally-blackened periphery of the display device 192 riot configured to present images, user interfaces, application windows, etc. It is to be further understood that the at least one light 193 may be configured to change colors emitted therefrom under control of the processor 122 such as e.g. being configured to emit green light, orange light, blue light, red light, and/or yellow light. Notwithstanding, it is to be understood that in some embodiments the at least one light 193 may be plural lights each being respectively configured to emit light of a different color such as e.g. green light, orange light, blue light, red light, and yellow light.

Still further, the system 100 includes a vibrating element 195 that may be and/or include e.g. a motor for moving an eccentric weight of the vibrating element to generate a vibration at the system 100. Additionally, though now shown for clarity, in some embodiments the system 100 may include a gyroscope for e.g. sensing and/or measuring the orientation of the system 100 and providing input related thereto to the processor 122, an accelerometer for e.g. sensing acceleration and/or movement of the system 100 and providing input related thereto to the processor 1 an audio receiver/microphone providing input to the processor 122 e.g. based on a user providing audible input to the microphone, and a camera for gathering one or more images and providing input related thereto to the processor 122. The camera may be, e.g., a thermal imaging camera, a digital camera such as a webcam and/or a camera integrated into the system 100 and controllable by the processor 122 to gather pictures/images and/or video.

Moreover, and also not shown for clarity, the system 100 may include a GPS transceiver that is configured to e.g. receive geographic position information from at least one satellite and provide the information to the processor 122. However, it is to be understood that another suitable position receiver other than a OPS receiver may be used in accordance with present principles to e.g. determine the location of the system 100.

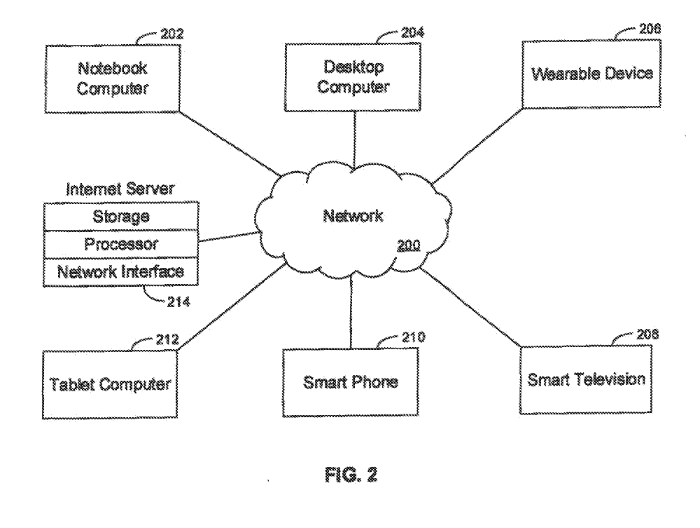

Before moving or to FIG. 2, it is to be understood that an example client device or other machine/computer may include fewer or more features than shown on the system 100 of FIG. 1. In any case, it is to be understood at least based on the foregoing that the system 100 is configured to undertake present principles.

Turning now to FIG. 2, it shows example devices communicating over a network 200 such as e.g. the Internet in accordance with present principles. It is to be understood that e.g. each of the devices described in reference to FIG. 2 may include at least some of the features, components, and/or elements of the system 100 described above. In any case, FIG. 2 shows a notebook computer 202, a desktop computer 204, a wearable device 206 such as e.g. as smart watch, a smart television (TV) 208, a smart phone 210, a tablet computer 212, and a server 214 in accordance with present principles such as e.g. an Internet server that may e.g. provide cloud storage accessible to the devices 202-212. It is to be understood that the devices 202-214 are configured to communicate with each other over the network 200 to undertake present principles.

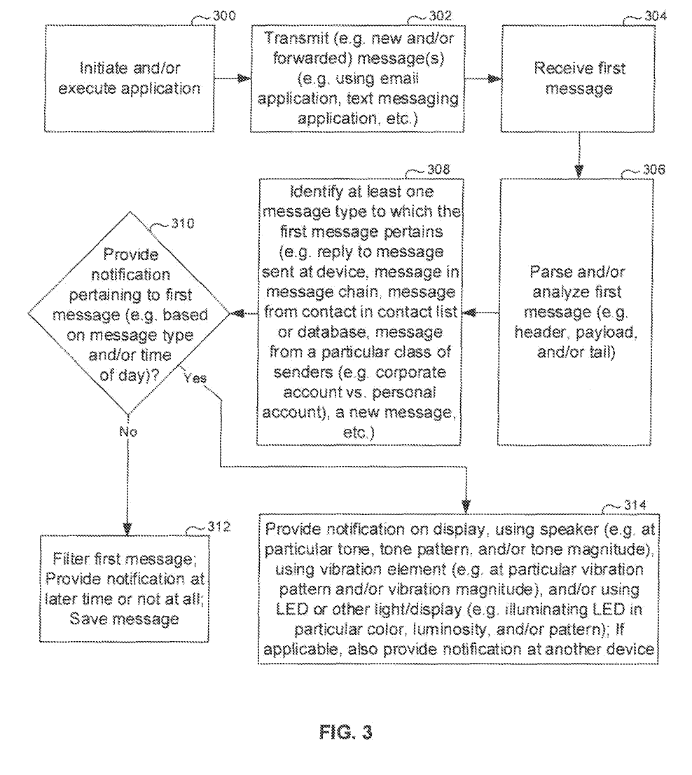

Referring to FIG. 3, it shows example logic that may be undertaken by a device such as the system 100 in accordance with present principles. Beginning at block 300, the logic initiates and/or executes an application for determining whether to provide a notification and/or alert at the device undertaking the present logic (referred to below as the “present device”) pertaining to a received message based on the type of message in accordance with present principles. The logic then moves to block 302 where the logic transmits (e.g. in response to a command from a user) on or more e.g. new and/or forwarded messages from the present device to another device. The transmission may be executed at least in part using an email application and/or text messaging application with which the application initiated and/or executing at block 300 interfaces.

From block 302 the logic moves to block 304, at which the logic receives a message (referred to below as the “first message”) from another user, device, email account, etc. The logic then proceeds to block 306 where the logia pares and/or analyzes the first message for data useful to determine at least one message type to which the first message pertains. For example, the header, payload, and/or to it of the first message may be parsed. After block 306 the logic moves to block 308.

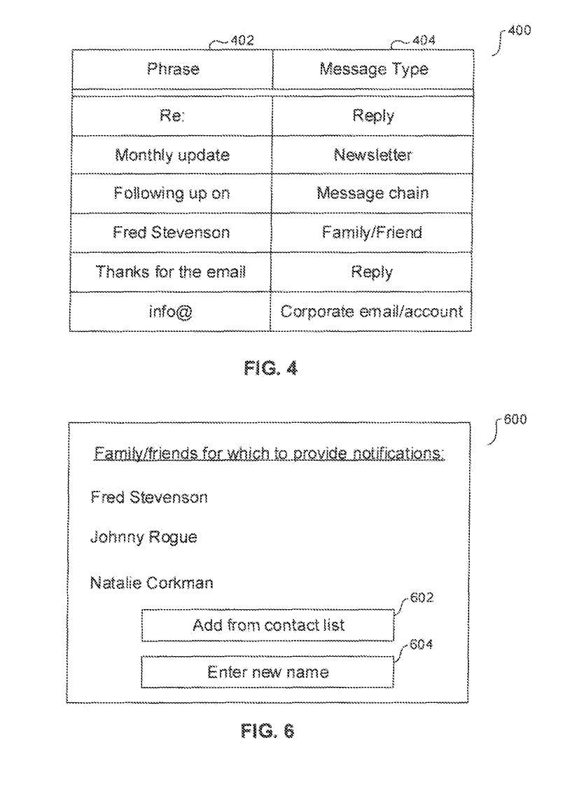

At block 308, the logic identifies at .least. one message type and possibly plural message types to which the first message pertains. Examples of message typos include e.g. a reply to a message sent from the present device (e.g. sent at block 302), a message in a message chain and/or a threaded message (e.g. a threaded message in which one or plural other messages associated with, continuing a thread, and/or and responding to previous messages have already been transmitted to and/or from the device by one or more other devices and/or people prior to receipt of the first message which may also continue the thread, a new message (e.g. a first message it a message chain) and/or a forwarded message, a message from a known contact (e.g. a contact in a contact list accessible by the present device), and a message from a particular class of senders such as e.g. from a sender designed by the user as being in a “family and friends” class or from a personal account (e.g. email account) as opposed to a corporate one (e.g. one beginning with the phrase “info” such as info@email.com), etc. Furthermore, note that in some embodiments the logic may determine message type by e.g. identifying a word or phrase identified at block 306 when parsing, and/or analyzing the first message, accessing a data table which correlates words and phrases to message types (e.g. such as the table 400 of FIG. 4 to be described below), and matching the word or phrase to a entry in the data table to thus identify a corresponding message type for the entry with which the word or phrase is associated,

In any case, at block 308 the logic proceeds to decision diamond 310, where the logic determines whether to provide a notification and/or alert at the present device pertaining to the first message based on the message type identified at block 308, notification settings for the respective message type that is identified such as those to be described below, and/or e.g. a time of day for which notifications of messages of that type are to be provided as e.g. also specified by the user. A negative determination at diamond 310 causes the logic to proceed to block 312, at which the logic may filter the first message in that e.g. a notification and/or alert may not be provided but the message may still be stored at the present device for viewing when desired by the user. Also at block 312, the device may set a notification to be provided at a later tune based on e.g. the notification settings for the respective message type referenced above and/or may determine to not provide a notification at any later time and to thus e.g. simply provide the first message itself to the user when the user accesses an application for viewing the message (e.g. an email application).

However, if an affirmative determination is instead made at diamond 310, the logic instead proceeds to block 314, at which the logic provides a notification and/or alert regarding the first message e.g. on a display of the present device such as the display device 192 described above, using a speaker such as the speaker 194 described above (e.g. providing a notification in a particular tone, tone pattern, and/or tone magnitude), using a vibration element such as the element 195 described above (e.g. at a particular vibration pattern and/or vibration magnitude), and/or using a light emitting diode (LED) or other light such as the light 19 described above (e.g. illuminating the LED in a particular color, luminosity level, and/or pattern). Furthermore note that in some embodiments if a user has configured the device to provide notifications regarding messages of the identified message type at another device in addition to or in lieu of at the present device (e.g. using one or more of the notification types described earlier in this paragraph), the logic may also at block 314 provide such a notification at the other device as specified by the user.

Now in reference to the aforementioned FIG. 4, it shows a data table 400 which may be accessed by the device executing the logic of FIG. 3 for e.g. identifying a message type to which a received message pertains based on data (e.g. text) in the message. Thus, upon accessing, parsing, and/or analyzing text in a message received at the device, the device ma access the data table 400 correlating words and phrases in respective entries in a first column 402 with respective message types for each entry in a second column 404 to thus match the word or phrase from the message to a may in the column 402 and accordingly determine a corresponding message type in column 404 for the entry, which may then be used in accordance with present principles for determining whether to provide a notification regarding the message based on message type.

As an example, the data table 400 may include an entry in the first column 402 for the phrase “Re:” such as may have been identified from e.g. a subject field of an email message and accordingly determine that the corresponding message type for the entry is a reply message. The table 400 may also include correlations such as e.g. the phrase “monthly update” being associated with a newsletter message type, the phrase “following up on” being associated with a message chain message type, the name “Fred Stevenson” as may be identified from metadata in a message being associated with a family/friend class message type, the phrase “thanks for the email” being associated with a reply message type, and an email address for the sender of a received message beginning with “info@” being associated with a corporate email account message type.

Continuing the detailed description in reference to FIG. 5, it shows an example user interface (UI) 500 for configuring settings of a device and/or application undertaking present principles. The UI 500 lists various message types for which the device has been configured and/or may be configured to provide one or more notifications of various notification types in accordance with present principles. Each message type listed (e.g. replies to messages sent from the device presenting the UI 500, newsletters, and senders of received messages which arc in a contact list accessible by the device presenting the UI 500) may have one or more selector elements associated therewith. Thus, each of the message types may have e.g. a specify times selector element 502 which may be selectable to e.g. present a pop-up and/or overlay window, and/or present another UI, for configuring particular times (and/or locations as may be determined using GPS data from a GPS receiver on the device) at which notifications of the associated message type may be provided, such as e.g. always, only during business hours (e.g. from 8:00 a.m. to 5:00 p.m. and only when the device is located at one or more places of business and/or a location designated by a user of the device as a work location), during personal hours (e.g. after 5:00 p.m. and only when the device is located at a location designated by a user of the device as residence location), etc.

Each of the message types ma also have a remove selector element 504 to remove the message type from the UI 500 and hence delete and/or remove an configurations or settings for the respective message type associated therewith, E.g., in some embodiments and responsive to selection of the selector element 504 for a respective message type, the device may be configured to not have any notification settings for the respective message type associated therewith and hence no notifications will be provided in response to receipt of future messages of the message type.

In addition to the foregoing, each of the message types may also have one or more selector elements 506 and 508 associated therewith for selecting one or more message formats for which to provide notifications of the respective message typo and message format, such as e.g. email message formats, short message service (SMS) message formats, etc. Note that the shading of the selector elements 506 and 508, and indeed shading shown on other of the selector elements shown on the UI 500, denote that the shaded selector elements are ones that have been selected by a user to thus configure the device to provide notifications in accordance with the function associated with the respective shaded selector element. Thus, e.g., notifications of the message type “replies to my messages” may be provided in response to receiving reply messages in both text message and email formats.

Still further, each of the message types may also have one or more selector elements associated therewith for selecting one or more notification types for notifications which are to he provided in response to receiving a message of the respective message type. Thus, e.g. a selector element 510 is selectable to p vide notifications for the respective message type as audible tones (e.g. at least a portion of a song, a sequence of notes, etc.), a selector element 512 is selectable to provide notifications for the respective message type as vibrations, and a selector element 514 is selectable to provide notifications for the respective message type by illuminating one or more LEDs. It is to be understood that in some embodiments more than one of the elements 510-514 may be (e.g. concurrently) selected to thus configure the device to present notifications in plural types depending on which of the elements 510-514 are selected.

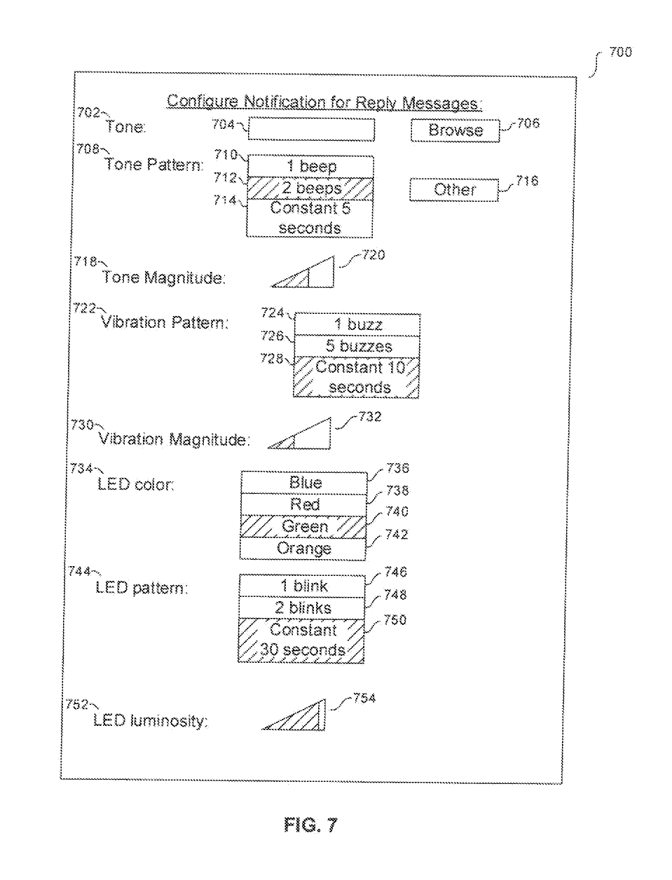

Also note that a configure selector element 516 may also be presented for the notification type selector elements which is selectable to configure settings or each type of notification selected using the elements 510-514. Thus, in one embodiment the selector element 516 may be selectable to automatically without further user input responsive thereto cause the device to present the UI 700 of FIG. 7, which will be described below.

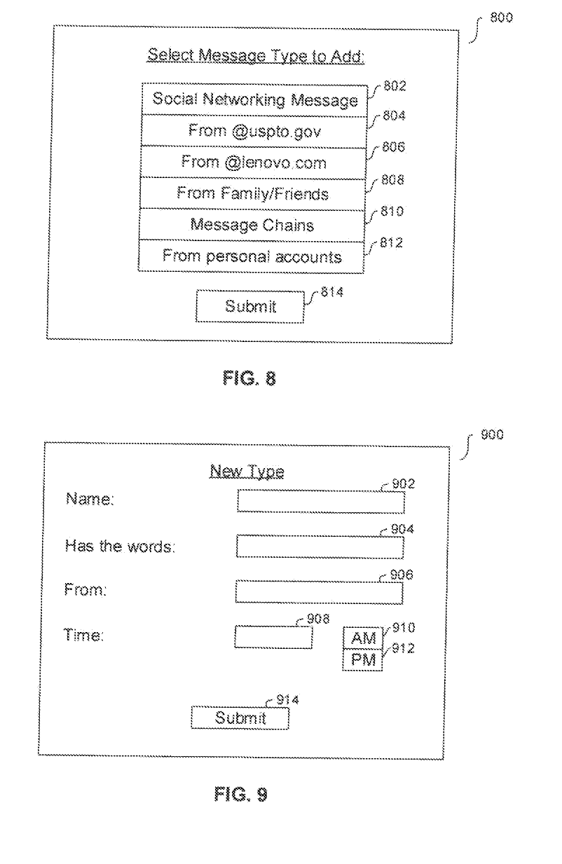

Still in reference to FIG. 5, note that the UI 500 may also include a select new selector element 518 which is selectable to add another message type to the UI 500 for configuring notification settings to be associated with the other message type. Thus e.g. in one embodiment, selection of the element 518 may automatically without further user input responsive thereto cause the device to present the UI 800 of FIG. 8, which will be described below. What's more, the UI 500 may include a create new selector element 520 which is selectable to create a new message type and (e.g. automatically) add it to the 500 for configuring notification settings to be associated with this new message type. Thus, e.g. in one embodiment, selection of the element 520 may automatically without further user input responsive thereto cause the device to present the UI 900 of FIG. 9, which will be described below.

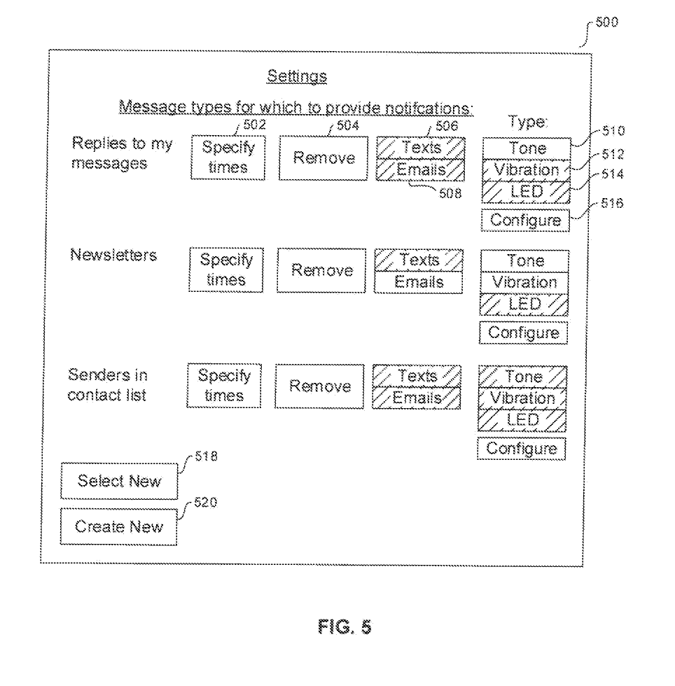

Now in reference to FIG. 6, it shows a UI 600 for configuring message type pertaining to a particular class of senders (e.g. for which to provide notifications in accordance with present principles upon receipt of a message from one of those senders). in the present example, the class is called “family/friends” and as may be appreciated from the 600 the user has designated the people Fred Stevenson, Johnny Rogue, and Natalie Corkman to be senders included in the class. The UI 600 also includes a selector element 602 selectable to add another sender to the class based on a selection from a contact list (e.g. a representation of which may be overlaid on the UI 600, and/or separately presented, automatically without further user input responsive to selection of the element 602) accessible to the device presenting the UI 600. A selector element 604 is also shown for entering a new sender to add to the class (e.g. by presenting and/or overlaying a text entry box for entry of the name to thus configure the device to provide notifications in accordance with the family/friend class settings when a message As received from a sender specified using the text entry box and/or which includes the name entered to the text entry box).

Moving on in the detailed description with reference to FIG. 7, it shows a UI 700 for configuring settings for respective types of notifications, such as e.g. one or more types selected using the elements 510-514 described above. Thus, e.g. note that in some embodiments the UI 700 for a given message type may dynamically change based on which selector elements 510-514 have been selected for the respective message type, such that e.g. if only the elements 512 and 514 have been selected then options are only presented for vibration and LED notification types, but if each of the elements 510-514 is selected then the UI 700 may include options for tone, vibration, and LED notification types as shown in example FIG. 7.

In any case, the UI 700 includes a first setting 702 for selecting a tone in which to provide a notification (e.g. a song), The setting 702 this includes an entry box 704 for inputting and/or specifying a tone, along with a browse selector element 706 selectable to browse to a tone file accessible to the device for selection and/or automatic entry to the box 704. The UI 700 also includes a setting 708 for selecting a tone pattern (e.g. when the tone, is a particular note or chime), and thus one or more selector elements 710, 712, and 714 are shown for configuring the device to present a notification in respective tone patterns of one beep, two beeps (e.g. equal lengths and separated a period of no tone), or a constant tone for five seconds (e.g. note that in some embodiments the length of the constant tone may be specified by the user). Also note that should another tone pattern be desired, the user may select an other selector element 716 for inputting and/or selecting another tone pattern other than those associated with the elements 710-714. Still further, yet another setting 718 is shown for selecting a particular tone magnitude (e.g. of Rune level) for the tone and/or tone pattern. Thus, a level element 720 is shown which is manipulable to establish the tone magnitude based on selection of a particular portion or area of the element 720 relative to a maximum for the tone magnitude as represented by the right-most portion of the element 720. Note that the shaded portion of the element 720 denotes the particular level selected in the example shown.

The UI 700 of FIG. 7 may also include a setting for selecting a vibration pattern at which to actuate a vibration element as a notification of receipt of a message of a message type to which the UI 700 pertains. Thus, selector elements 724, 726, and 728 are respectively selectable to establish the vibration pattern at one buzz, five buzzes or a constant vibration for ten seconds, although it is to be understood that a user may specify still other patterns. In addition to vibration pattern, vibration magnitude for the pattern may also be established using the setting 730 by manipulating the level element 732, which is manipulable to establish the vibration magnitude based on selection of a particular portion or area of the element 732 relative to a maximum for the vibration magnitude as represented by the right-most portion of the element 732. Note that the shaded portion of the element 732 denotes the particular level selected in the example shown.

Still in reference to FIG. 7, the UI 700 may further include a setting 734 for selecting a light color for which to activate a light (e.g. an LED) on the device as a notification of receipt of a message of a message type to which the UI 700 pertains. Thus, selector elements 736, 738, 740, and 742 are respectively selectable to establish the light color to be blue, red, green or orange, although it is to be understood that a user may specify still other colors. A setting 744 is shown for establishing a pattern at which to actuate the light to present the color selected at setting 734. Selector elements 746, 748, and 750 are thus respectively selectable to establish the pattern to be one blink of the light, two blinks of the light, or constant actuation of the light for thirty seconds, although it is to be understood that a user may specify still other numbers of blinks and/or lengths of time.

Last, the example UI 700 includes a setting 752 for establishing a level of luminosity at which to provide the light-based notification using level selector element 754. The element 754 is manipulable to establish the luminosity based on selection of a particular portion or area of the element 754 relative to a maximum for the luminosity as represented by the right-most portion of the element 754. Note that the shaded portion of the element 754 denotes the particular level selected in the example shown.

Now in reference to FIG. 8, it shows a UI 800 for electing one or more message types for which to configure settings for providing notifications upon receipt of a message of the respective message type (e.g. for selecting one or more message types to add to the UI 500 and configure settings therefrom). The UI 800 thus includes predetermined and/or preset (e.g. automatically by the device using context awareness principles and/or artificial intelligence principles, and/or by a provide sit the application undertaking present principles) selector elements 802, 804, 806, 808, 810, and 812 for respectively selecting message types pertaining to social networking messages, messages from email accounts ending in messages, from email accounts ending in “@lenovo.com,” messages from the class family/friends, message chains, and messages from persona; (e.g. email) accounts (e.g. as opposed to corporate ones). Also note that the UI 800 includes a submit selector element 814 to e.g. add one or more of the message types selected using one or more of the elements 802-812 to the UI 500 for configuration of notifications for each respective message type therefrom.

Describing FIG. 9, it shows a UI 900 for creating a new message type for which to configure notifications to be provided in response to receipt of a message of the new message type in accordance with present principles. The UI 900 thus includes a text entry box 902 for inputting a name for the new message type, a text entry box 904 for inputting one or more words and/or phrases which if identified from a received message may be determined to be a message of the new message type, a text entry box 906 for inputting one or more senders for which to associate with the new message type, and an entry box 904 for inputting one or more times at which to provide notifications regarding a received message of the new message type (e.g. if it is desired to not automatically and/or immediately provide a notification of a received message of the new message type) in accordance with present principles. Thus, note that selector elements 910 and 912 are shown for respectively selecting whether the time entered at box 908 is an a.m. time or p.m. time. Last, note that the UI 914 may include a submit selector element which may be selectable to automatically without further user input responsive thereto configure the device to provide notifications upon receipt of messages of the new message type per the configurations input using the UI 900, and/or may be selectable to automatically without further user input responsive thereto add the new message type to the UI 500 per the configurations input using the UI 900.

Without reference to any particular figure, it is to be understood that should a device in accordance with present principles determine that is message pertains to and/or may be associated with more than one message type, in some embodiments one or more notifications regarding the message may be provided according to each respective message type to which the message is determined to pertain. Thus, e.g., should it be determined that a received message pertains to both a reply message type and a friends/family class message type, where notifications regarding messages of the reply message type are configured to only be provided as vibration notifications and messages of the friends/family class message type are configured to only be provided based on illumination of an LED, notifications may be provided for the received message as both a vibration notification and an LED-based notification. However, note that in other embodiments e.g. using a UI a user may rank based on priority message types such that should a message be determined to pertain to plural message types, then a notification is provided regarding the message per the notification configuration for the highest-ranked of the plural message types.

Also without reference to any particular figure, still other ways of determining a message type for a received message may be used, such as e.g. analyzing a message format (e.g. the format of an email) to determine if the message is a “newsletter” type of message complete with a unique or organization-specific border surrounding the message text, or is instead a message containing personalized text. A logo may be identified in a message to determine that the message is from an e.g. corporate account and not a personal account, and furthermore e.g. a message relatively plentiful HTML content may be determined to not be a personalized message. Text recognition may also be used in accordance with present principles. As a specific example, if the message contains the wording “Text ‘stop’ to stop receiving messages,” the device may determine that the message is a mass message and not a personalized one for which a notification should be provided. Furthermore, sender information e.g. contained in a header portion of a received message may be parsed to identify information pertaining to the sender such as e.g. whether the sender is identified only under an alias of some sort or whether an actual name is specified.

As another example of message type, a message type may be any message pertaining to an event currently occurring as indicated on an electronic calendar accessible to the device, where any message de ermined to not pertain to the event will upon receipt not cause the device to present a notification. Thus, e.g. assume a meeting has started for which an entry has been placed in an electronic calendar. The device may then receive a message with a phrase such as “when is our meeting?” and determine based on electronic calendar information that the meeting is supposed to be currently occurring with that particular sender listed as an attendee, and hence determine to provide a notification regarding the received message containing the phrase.

It may now be appreciated that present principles provide for, among other things, allowing a user to elect to be notified when they get email/SMS messages to their smart phone based on message type via vibration, ring tone, or flashing LED. Notifications may be provided for types of messages including e.g. messages that are being sent as a reply to user messages while filtering messages that are new or forwarded messages, messages from known contacts as opposed to unknown ones, and/or threaded messages (e.g., specifically that arrive within time threshold of the user sending a message in the thread from their device (it being noted that this time threshold may apply to e.g. any reply message received within a threshold time of transmission of a message from the device that received the reply and not just messages in a thread)). Newsletters may be filtered out, if desired, such that no notification regarding their receipt is provided. Furthermore, the principles described herein are understood to apply equally to e.g. text messages (e.g. SMS) e.g. to detect automated text messages versus messages from a person, and provide notifications upon determinations that received messages are from a person rather than being an automated text message.

Before concluding, it is to be understood that although e.g. a software application for undertaking present principles may be vended with a device such as the system 100, present principles apply in instances where such an application is e.g. downloaded from a server to a device over a network such as the Internet. Furthermore, present principles apply in instances where e.g. such an application is included on a computer readable storage medium that is being vended and/or provided, where the computer readable storage medium is not a earlier wave and/or a signal per se.

While the particular PROVIDING NOTIFICATION PERTAINING TO MESSAGE BASE ON MESSAGE TYPE is herein shown and described in detail, it is to be understood that the subject matter which is encompassed by the present application is limited only by the claims.

What is claimed is:

1. A device comprising:
a processor;
a memory accessible to the processor and bearing instructions executable by the processor to:
receive a first message;
identify at least a first type of message to which the first message pertains; and
determine whether to provide a notification at the device pertaining to the first message based on the identification.

2. The device of claim 1, wherein the instructions are further executable to:
provide the notification at the device in response to a determination to pro e the notification.

3. The device of claim 2, comprising at least one speaker, and wherein the notification comprises a tone, of a first tone pattern different from a second tone pattern for which a notification is provided in response to identification of a second message type to which a second message pertains, the tone provided using the speaker.

4. The device of claim 2, comprising at least one speaker, and wherein the notification comprises a tone of a first magnitude different from a second magnitude for which a notification is provided in response to identification of a second message type to which a second message pertains, the tone provided using the speaker.

5. The device of claim 2, comprising at least one vibration element, and wherein the notification comprises a vibration of a first vibration magnitude different from a second vibration magnitude for which a notification is provided in response to identification of a second message type to which a second message pertains, the vibration provided using the vibration element.

6. The device of claim 2, comprising at least one vibration element, and wherein the notification comprises a vibration of a first vibration pattern different from a second vibration pattern for which a notification is provided in response to identification of a second message type to which a second message pertains the vibration provided using the vibration element.

7. The device of claim 2, comprising at least one light emitting diode (LED), and wherein the notification comprises activation of the LED in a first color different from a second color in which a notification is provided in response to identification of a second message type to which a second message pertains.

8. The device of claim 2, comprising at least one light emitting diode (LED), and wherein the notification comprises activation of the LED in a first pattern different from a second pattern in which a notification is provided in response to identification of a second message type to which a second message pertains.

9. The device of claim 2, comprising at least one light emitting diode (LED), and wherein the notification comprises activation of the LED in a first level of luminosity different from a second level of luminosity in which a notification is provided in response to identification of a second message type to which a second message pertains.

10. The device of claim 1, wherein the first message type is a message in a message Chain in which a second message has already been transmitted from the device prior to receipt of the first message.

11. The device of claim 10, wherein the second message type is selected from the group consisting of: a new message, a forwarded message.

12. The device of claim 1, wherein the first message type is a message from a contact in a contact database accessible to the device.

13. The device of claim 1, wherein the first message type is a message from a particular class of senders designated by a user.

14. A method comprising:
receiving a first message at a device; and
determining whether to provide a notification regarding the first message based on a first message type to which the first message pertains.

15. The method of claim 14, further comprising:
identifying the first message type to which the first message pertains and;
in response to the identification of the first message type, determining whether to provide the notification.

16. The method of claim 15, further comprising:
providing tie notification at the device.

17. The method of claim 14, wherein the notification comprises at least one of the group consisting of: a tone of as first tone pattern different from a second tone pattern for messages of a second message type, a tone of a first magnitude different from a second tone magnitude for messages of a second message type, a vibration of a first vibration magnitude different from a second vibration magnitude for messages of a second message type, a vibration of a first vibration pattern different from a second vibration pattern for messages of a second message type, activation of a light emitting diode (LED) in a first color different from is second color for messages of a second message type, activation of a LED in a first pattern different from a second pattern fix messages of a second message type, activation of a LED in a first level of luminosity different from a second level of luminosity for messages of a second message type.

18. The method of claim 14, wherein the first message type is selected from the group consisting of: a message in a message chain in which a second message has been transmitted from the device prior to receipt of the first message, a message from a contact in a contact list accessible to the device, a message from a particular class of senders designated by a user.

19. An apparatus, comprising:
a first processor;
a network adapter;
storage hearing instructions executable by a second processor for:
determining whether to provide an alert at a device pertaining to at least one message received at the device based on a message type to which the message pertains;
wherein the first processor transfers the instructions over a network via the network adapter.

20. The apparatus of claim 19, wherein the instructions are executable for:
determining whether to provide an alert at the device pertaining to at least one message received at the device based on a message type to which the message pertains and based on a current time of day; and
in response to determining to provide an alert at the device, providing the alert at the device.
